(19) United States
(12) Patent Application Publication
(10) Pub. No.: US 2002/0163244 A1
(43) Pub. Date: Nov. 7, 2002

(54) Garbage compactore lock device for a garbage truck

(76) Inventor: Sen-Hui Liu, Chungho City (TW)

Correspondence Address: Gerald T. Shekleton, Esq., Welsh & Katz, Ltd, 22nd Floor, 120 S. Riverside Plaza, Chicago, IL, 60606, US

(21) Appl. No.: 09/846,968

(22) Filed: May 1, 2001

(51) Int. Cl. B60P 1/00

(52) U.S. Cl. 298/38

(57) ABSTRACT

A lock device for a garbage compactor of a garbage truck has two cylinders, two connecting bars, two linkages and two hooks. The cylinders are mounted on opposite sides of the garbage compactor. Each connecting bar is connected to one end of a piston rod extending from the cylinder. Each linkage is connected to the other end of the corresponding connecting bar. A hook is pivotally connecting to the linkage and pivotally mounted on the garbage compactor. The hook has a downward engaging portion to engage a post on the garbage compartment. Accordingly, the hooks will not disengage from the posts when a shock occurs. In addition, since a cylinder is used on each side of the trash compactor, the peak load on each cylinder can be reduced, and the useful life of each cylinder is prolonged.

### BACKGROUND OF THE INVENTION

1. Field of the Invention

The present invention relates to a lock device, and more particularly to a garbage compactor lock device for a garbage truck to securely lock the garbage compactor to the garbage compartment on the garbage truck.

2. Description of Related Art

With reference to FIGS. 4 and 5, a garbage compactor (50) is pivotally mounted on the garbage compartment (40) of a garbage truck to close the open end of the garbage compartment (40). A lock device is arranged between the garbage compactor (50) and the garbage compartment (40) to lock the garbage compactor (50) onto the garbage compartment (40). The conventional lock device in accordance with the prior art comprises an axle (42), a cylinder (not shown), two linkages (44) and two hooks (45). The axle (42) pivotally extends through two plates (41) respectively mounted on opposite sides of the garbage compartment (40). A tab (43) is secured to each end of the axle (42) to rotate with the axle (42). A piston rod (not shown) extends from the cylinder and connects to the axle (42) to rotate the axle (42). Each linkage (44) has two ends. One end of each linkage (44) is pivotally connected to the corresponding tab (43) mounted on the axle (42). The other end of each linkage (44) is pivotally connected to the corresponding hook (45). Each hook (45) is pivotally attached to one side of the garbage compartment (40) with a pivot pin (46). Each hook (45) has a central pivot hole (not numbered) and two ends. A linkage (44) is pivotally connected to one end of each hook (45). an upward engaging portion (452) is formed on the other end of the hook (45) to engage with an eye (51) mounted on the garbage compactor (50). Consequently, the garbage compactor (50) will be held securely closed due to the engagement between each hook (45) and the corresponding eye (51).

When the cylinder is actuated and the piston rod rotates the axle (42) , each hook (45) will rotate relative to the pivot pin (46) and disengage from the corresponding eye (51) by the transmission of the tab (43) and the linkage (44). The garbage compactor (50) can then pivot relative to the garbage compartment (40), and the garbage compartment (40) is opened. The garbage stored in the garbage compartment (40) can be dumped.

However, because the hook (45) of the conventional lock device has an upward engaging portion (452), the hook (45) engages with the corresponding eye (51) from the bottom of the eye (51). Consequently, the hook (45) can easily disengage from the eye (51) when a shock occurs especially when the garbage truck is moving. The garbage compactor (50) will not close the garbage compartment (40), and garbage or waste fluids will drop from the garbage compartment (40). Pollution and sanitary problems will occur.

Additionally, only a cylinder is used to actuate the two hooks (45) in the conventional lock device. When a large amount of garbage is compressed in the garbage compartment (40), a high pressure will push against the garbage compactor (50). The load on the cylinder to keep both hooks (45) in engaged positions is very heavy. The cylinder is easily damaged by the application of the high pressure over an extended period of use.

To overcome the shortcomings, the present invention provides an improved lock device to mitigate or obviate the aforementioned problems.

### SUMMARY OF THE INVENTION

The main objective of the invention is to provide an improved garbage compactor lock device for a garbage truck that will not disengage from the garbage compartment when a shock occurs. The lock device has two cylinders, two connecting bars, two linkages and two hooks. The cylinders are mounted on opposite sides of the garbage compactor. Each connecting bar has two ends, and one end is connected to a cylinder. A linkage is connected to the other end of each connecting bar. A hook is pivotally connecting to the linkage and pivotally mounted on the garbage compactor. Each hook has a downward engaging portion to engage a post on the garbage compartment. With such an arrangement, because the each hook engages with the corresponding post from the top of the post, the hooks will not disengage from the posts when a shock occurs. In addition, because two cylinders are used to hold the lock device in the locked position, the peak load on each cylinder can be reduced.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of a garbage compactor lock device for a garbage truck in accordance with the present invention;

FIG. 2 is an exploded perspective view of the lock device in FIG. 1;

FIG. 3 is an operational side plan view of the lock device in FIG. 1;

FIG. 4 is a partial side plan view of a garbage truck with a conventional lock device in accordance with the prior art; and

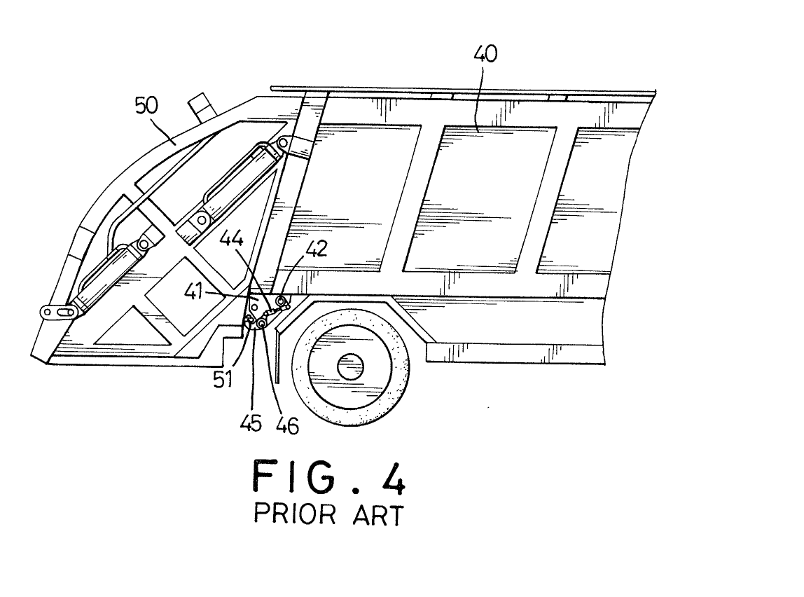

FIG. 5 is an enlarged operational side plan view of the conventional lock device in FIG. 4.

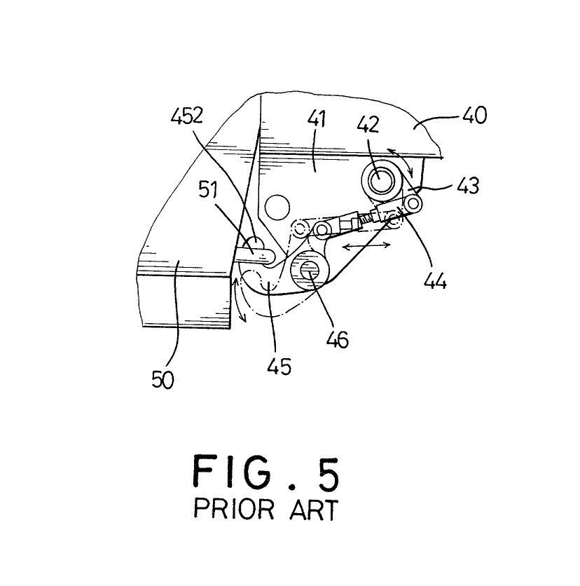

### DETAILED DESCRIPTION OF PREFERRED EMBODIMENT

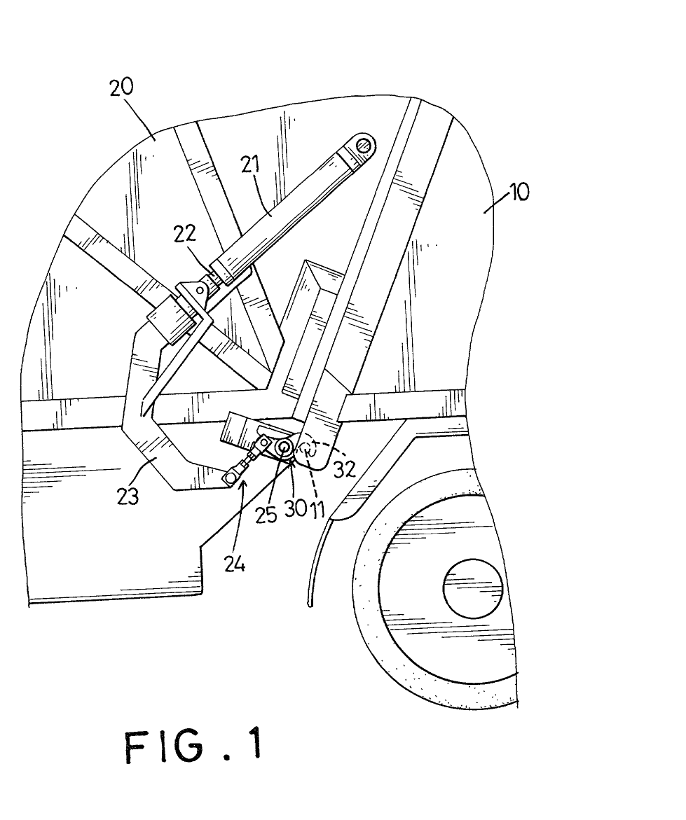

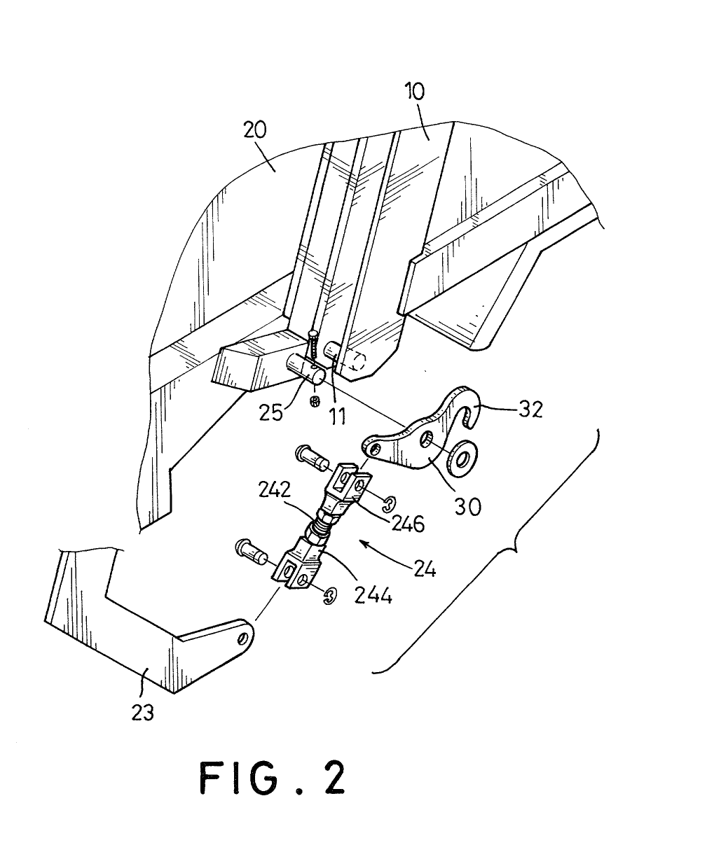

With reference to FIGS. 1 and 2, a garbage compactor lock device in accordance with the present invention for a garbage truck comprises two cylinders (21), two connecting bars (23), two linkages (24) and two hooks (30). A garbage compactor lock device is mounted on each side of a garbage compactor (20) for a garbage truck. Each cylinder (21) is securely attached to one side of the garbage compactor (20) and has a piston rod (22) extending from one end of the cylinder (21). In practice, the cylinder (21) can be mounted on the garbage compartment (10). Each connecting bar (23) has two ends, is substantially U-shaped and has one end connected to the corresponding piston rod (22) extending from the cylinder (21). Each linkage (24) has two ends. One end of the linkage (24) is connected to the distal end of the connecting bar (23)). The other end of the linkage (24) is pivotally connected to one of the hooks (30). Each hook (30) is pivotally attached to a pivot pin (25) mounted on one side of the garbage compactor (20). A downward engaging portion (32) is formed on each hook (30) at the distal end from the linkage (24) to engage the garbage compartment (10) and hold the garbage compactor (20) in position. In practice, a post (11) is mounted on each side of the garbage compartment (10) to be engaged by the engaging portion (32) of the hook (30).

When the piston rod (22) retracts into the cylinder (21), the engaging portion (32) of the hook (30) will rotate down and engage the post (11) by the transmission of the connecting bar (23) and the linkage (24). The garbage compactor (20) is locked and cannot be opened. Because the engaging portion (32) of each hook (30) is downward, each hook (30) engages with the corresponding post (11) from the top of the post (11). Consequently, the hooks (30) will not disengage from the posts (11) when a shock occurs. The garbage and the waste liquids will not drop from the garbage compartment (10). Pollution and sanitary problems will be avoided.

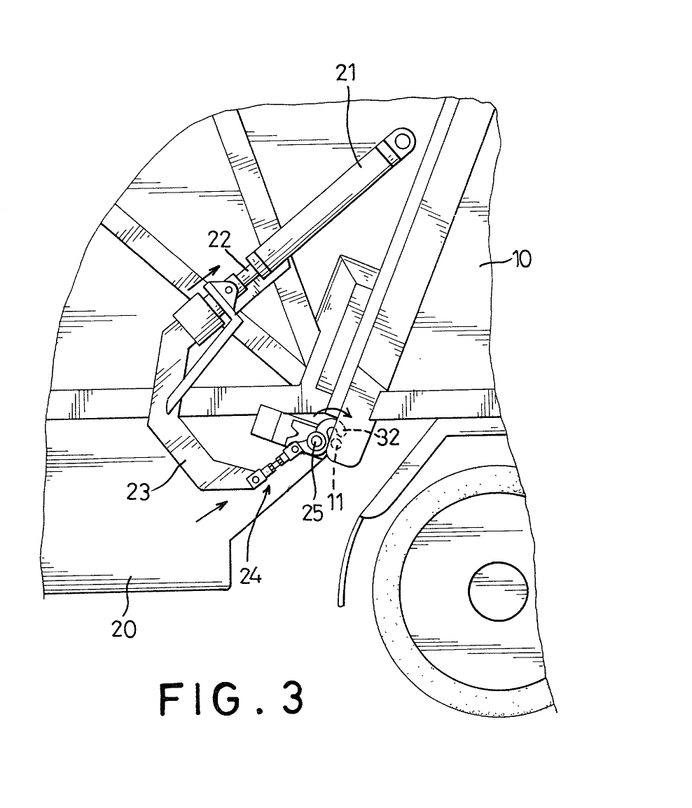

With reference to FIG. 3, when the piston rod (22) extending from the cylinder (21) is extended further from the cylinder (21), the engaging portion (32) of the hook (30) will rotate upward and disengage from the post (11) by the transmission of the connecting bar (23) and the linkage (24). The garbage compactor (20) is unlocked and can be opened, and garbage stored in the garbage compartment (10) can be dumped. Since a lock device is installed on each side of the garbage compactor (20), two cylinders (21) are used to hold the lock position of the lock devices, and the peak load on each cylinder (21) can be reduced. The useful life of each cylinder (21) is prolonged.

In addition, with reference to FIG. 2, each linkage (24) is adjustable in length and comprises a threaded rod (242) and two connecting members (244, 246). Each connecting member (244, 246) is screwed onto one end of the threaded rod (242). When one of the connecting members (244, 246) is rotated relative to the threaded rod (242), the length of the linkage (24) is changed. The adjustable linkage (24) can be applied to different types of garbage compactors (20) or garbage compartments (10). The scope of using the lock device is enlarged. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lock device for a garbage compactor on a garbage truck having a garbage compartment to which the garbage compactor is pivotally attached, the lock device comprising:
two cylinders each adapted to be mounted on opposite sides of the garbage compactor and each having a piston rod therein;
two connecting bars, each having two ends with one end connected to the piston rod that extends from the cylinder;
two linkages, each connected to the other end of the connecting bar; and
two hooks, each pivotally connecting to the linkage and configured for pivotally engaging with the garbage compactor,
wherein a downward engaging portion is formed on each hook for engaging the garbage compartment.

2. The lock device as claimed in claim 1, wherein each connecting bar is substantially U-shaped and has one end connected to the corresponding piston rod extending from the cylinder and the other end connected to the corresponding linkage.

3. The lock device as claimed in claim 1, wherein a post is adapted to be mounted on each side of the garbage compartment to be engaged by the engaging portion of the corresponding hook.

4. The lock device as claimed in claim 1, wherein each linkage includes a threaded rod and two connecting members each screwed onto one end of the threaded rod so that a length of the linkage is adjustable.
